(19) United States
(12) Patent Application Publication
(10) Pub. No.: US 2007/0162293 A1
(43) Pub. Date: Jul. 12, 2007

(54) Method for valuing used motor vehicles

(76) Inventor: Ohanis L. Malkon, Niles, IL (US)

Correspondence Address: MCANDREWS HELD & MALLOY, LTD, 500 WEST MADISON STREET, SUITE 3400, CHICAGO, IL, 60661, US

(21) Appl. No.: 11/329,261

(22) Filed: Jan. 10, 2006

(51) Int. Cl. G06Q 99/00

(52) U.S. Cl. 705/1

(57) ABSTRACT

A method for valuing a used motor vehicle provides an reliable and verifiable valuation based on information about the vehicle as provided by its manufacturer. The method considers the optional equipment with which the vehicle was originally provided in determining its value, and can also consider other originally provided information about the vehicle including manufacturer's pricing.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to purchase and sales of used motor vehicles and to an improved system for valuing used motor vehicles. More particularly, the present invention is directed to a system that values used motor vehicles based on a more reliable and accurate identification of the optional equipment with which the vehicle is equipped than has heretofore been available for use in determining the value of used motor vehicles.

The purchase and sale of used motor vehicles including automobiles and trucks is a significant industry that relies on estimates of the value of the used motor vehicles that are purchased and sold. Most motor vehicles are sold at least once as a used vehicle. Many vehicles are traded after use for newer vehicles and many leased motor vehicles are sold after the end of the lease term. Sellers and purchasers of used motor vehicles rely on estimates of the values of used motor vehicles in determining the prices at which they will sell and buy used motor vehicles, and lenders who finance purchase of used motor vehicles need reliable estimates of the values of used motor vehicles for which loans are made.

Lending for the purchases of used motor vehicles is a large industry that supports those businesses that purchase and sell used motor vehicles. Loans that are made for the purchase of used vehicles are generally secured by the purchased vehicles. The amount that a lender will loan for a purchase of a used motor vehicle depends on the value of the vehicle. To the extent that a lender cannot know the value of a used motor vehicle, the lender must either limit the amount that it is willing to lend for a used vehicle or risk that a loan cannot be paid by the value of the vehicle. For many reasons, lenders also need reliable and accurate valuations of used motor vehicles.

The value of a used motor vehicle depends on many factors. The make, model, age, and mileage of the used motor vehicle are fundamental factors that determine the value of a used motor vehicle, as is the condition of the vehicle. The optional equipment with which a used motor vehicle is equipped is also an important factor in determining the vehicle's value. While the effect depends on many factors, the value of a used motor vehicle can change by as much as 30 to 40 percent based on optional equipment with which the vehicle is equipped.

Services have provided estimated values of used motor vehicles based on information that is accumulated about sales of vehicles in various locations and forums. Those services provide an estimated value of a used motor vehicle based on comparing the description of a vehicle for which a value is requested to the sales of the same and similar vehicles at or near the location of the vehicle. Prior systems for valuing used motor vehicles have generally provided a value for an identified used motor vehicle based on the make, model, year and condition of the vehicle. Some valuing systems also consider optional equipment that is included in the vehicle. All estimates of the values of used motor vehicles depend on the accuracy of the information about the vehicle for which the value is estimated.

Verification of the description of a vehicle for which an estimated value has been provided is an important consideration in determining whether the estimated value is correct. Some of the important aspects of a used motor vehicle, including make, model, and year, are readily and objectively determined, and can be verified based on the vehicle's Vehicle Identification Number (VIN). Other factors, including the condition of the vehicle, are at least in part based on subjective valuations and introduce uncertainty into the valuation process. Identification of optional equipment, has also been a source of uncertainty. VIN numbers include sequences of characters that, to an extent, provide some description of the vehicle and its equipment. Those identifications are not complete nor precise as to a particular vehicle's optional equipment. Therefore, identification of optional equipment has been based on inspection of the vehicle.

Identification by inspection of optional equipment included in a used motor vehicle is not always complete or accurate. Some optional equipment is more apparent than others. Even when optional equipment is apparent, inspections frequently do not accurately identify all optional equipment, and can report optional equipment that is not included in the vehicle. Errors in identifying optional equipment can make the vehicle appear to be more valuable than it is, in the case of incorrectly included optional equipment, or may make the vehicle appear to be less valuable in the case of omitted equipment. Inadvertent errors as well as the possibility of deliberately inaccurate reports, and the lack of an independent source of information about a vehicle's optional equipment have made identification of optional equipment a source of uncertainty in valuing used motor vehicles.

Inaccuracy of the estimated value of a used motor vehicle is an important concern for both lenders and borrowers who rely on the estimated value. Lenders who are faced with uncertainty of the value of a used motor vehicle because of uncertainty as to the optional equipment that is included in the vehicle have had two options to address that uncertainty. A lender can either arrange for an independent and knowledgeable inspection of the vehicle, or can limit the amount loaned for purchase of the vehicle by ignoring the value of optional equipment. The first option adds expense to the loan. The second may limit the lender's opportunities to make loans and may interfere with a borrower's opportunity to purchase the used motor vehicle.

In addition to concerns raised by uncertainty as to optional equipment that is included in a used motor vehicle, prior systems for valuing used motor vehicles are generally limited by the amount of prior sales information that has been accumulated. This limitation is encountered when an estimated value is needed for a very recently manufactured vehicle that has been used. Because sufficient sales information has not been accumulated, prior systems have not provided estimates of the value of very recently manufactured, but used, motor vehicles.

A need exists for a system for valuing used motor vehicles that will more quickly and accurately value used motor vehicle than systems that have been known. In addition, a need exists for a system that values used motor vehicles based on more accurate identification of optional equipment that is included in the vehicle than has previously been known. Further, a need exists for a system that provides an estimate or a basis to estimate the value of recently manufactured vehicles.

### BRIEF SUMMARY OF THE INVENTION

To address problems that are identified in the preceding section and others, the present invention provides a method for valuing used motor vehicles that will more quickly and accurately estimate the value of an identified used motor vehicle based at least in part on optional equipment that was installed in the vehicle by its manufacturer than have prior systems. The method includes the steps of identifying the vehicle, determining the optional equipment with which the vehicle was equipped based when originally sold by its manufacturer, and valuing the vehicle based in part on that identified optional equipment.

In an additional particular aspect of the invention, the method may include identifying the equipment with which the used motor vehicle is presently equipped by inspection, and comparing the optional equipment with which the vehicle was originally sold to the optional equipment that is reported by the inspection. This step can verify the accuracy of the inspection by both supporting the report of included equipment and identifying equipment that may have not have been identified by the inspection.

In yet another particular aspect, the method may also include determining the original manufacturer's pricing and/or suggested pricing for the vehicle. As original pricing reflects the optional equipment with which the vehicle was sold, that pricing can suggest an estimated value in combination with other factors, as well as confirm the existence and value of originally installed optional equipment.

The system according to the present invention provides a more accurate valuation of a used motor vehicle than do known methods by always considering optional equipment included with the vehicle and by substantially eliminating the need for, and errors caused by, manual identification of the optional equipment of a used motor vehicle.

### BRIEF DESCRIPTION OF SEVERAL VIEWS OF THE DRAWINGS

FIG. 1 is a chart that illustrates a method according to the present invention for valuing used motor vehicles.

FIG. 2 is a chart that illustrates another embodiment of a method according to the present invention for valuing used motor vehicles.

### DETAILED DESCRIPTION OF THE INVENTION

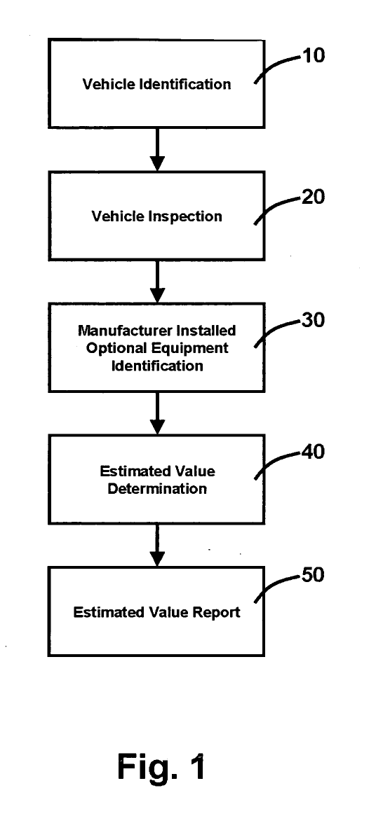

FIG. 1 is a flow chart illustration of a method according to the present invention for valuing a used motor vehicle. A vehicle identification step 10 of the method acquires identifying information for the vehicle to be valued. This step preferably includes acquiring conventional identification information including the year, make and model of the vehicle and its VIN.

An inspection step 20 of the method illustrated by FIG. 1 acquires information from an inspection of the vehicle. That information preferably includes the condition and configuration of the vehicle. This step may include evaluation of the vehicle condition generally, and may include determining specific conditions including mileage and operability of specific components and devices that are included with the vehicle. While inspection step 20 may most logically follow identification step 10, that order is not required. Further, the vehicle identification step and the vehicle inspection step need not be performed separately, but may be combined. Vehicle identification information may be based entirely on an inspection of the vehicle. What is required for this embodiment of the invention, is that both vehicle identification information and vehicle inspection information be acquired.

An original optional equipment identification step 30 identifies the optional equipment with which the used vehicle was equipped by its manufacturer. That information is extracted from a data collection that includes optional equipment with which vehicles were originally sold associated with identifying information for the vehicle. As presently preferred, the manufacturer installed optional equipment is determined from vehicles' original factory invoices. As also presently preferred, the vehicle identification which is used to identify the vehicle and its optional equipment is the vehicles VIN. The step 30 needs only vehicle identification information to be performed. Therefore, step 30 may be performed after the vehicle identification step 10, but may be performed before, after or simultaneously with the inspection step 20.

As presently preferred, the optional equipment identification step 30 identifies the originally installed optional equipment from a collection of information that is included in vehicles originally manufacturer's invoices. That information includes vehicle identification information, including at least the VIN, and the vehicles manufacturer installed optional equipment. The manufacturer installed optional equipment can be reported in response to an inquiry that for information for a vehicle that is identified by its VIN. Additionally, other information that is included in manufacturer's original invoices may be included in the information collection. For example, additional identification information such as vehicle model or other designation may be included as well as pricing information that is included in the manufacturer's original invoice. The collection of vehicle information is preferably a data collection that resides in electronic form an a computer, readable storage medium and that can be accessed by one ore more computers.

In a sequence in which optional equipment identification step 30 is performed after the inspection step 20, the step 30 may include verifying observations made in performing inspection step 20 by comparing those observations to the manufacturer installed optional equipment identified during step 30. In a sequence in which the optional equipment identification step 30 is performed prior to the inspection step 20, the step 30 may include identifying optional equipment to be inspected during the inspection step 20.

An estimated value determination step 40 is performed after identification of manufacturer installed optional equipment and after the vehicle is inspected. The estimated value of the used motor vehicle is determined based on some or all of the vehicle identification information that is obtained during the vehicle identification step 10, some or all of the vehicle inspection information that is acquired during the vehicle inspection step 20, and some or all of the manufacturer installed optional equipment information that is acquired during the optional equipment identification step 30. The estimated value determination step may determine a single estimated value of the vehicle, may report estimated values for each of a number of possible transactions including, for example, for sale of the vehicle to a dealer and for sale of the vehicle to a retail customer. The estimated value determination step 40 may report an estimated range of values that is consistent with the information and condition of the vehicle.

The estimated value determination step 40 may also compare vehicle optional equipment that is reported by the vehicle inspection step 20 to the optional equipment that is identified by the original optional equipment identification step 30. If the optional equipment that is identified by the vehicle inspection step 20 is not the same as the optional equipment that is identified by the original optional equipment identification step 30, an estimated value may be estimated based only on optional equipment that is confirmed to be present. In addition, a comparison of optional equipment that is identified by the steps 20 and 30 may be created and/or differences may be reported.

An estimated value report step 50 is performed after the estimated value determination step 40. The estimated value report step 50 reports the estimated value, values or range or ranges of values determined by the estimated value determination step 40. The estimated value report my also include additional information about the used motor vehicle which is assembled and used to determine the estimated value of the vehicle. For example, the report may include a listing of option equipment that has been identified as included in the vehicle and which was considered in determining the estimated value of the vehicle. The report may also include vehicle identification and vehicle inspection information that is acquired for the vehicle and on based on which the value is estimated. The report may also include a comparison of optional equipment that is identified by the original optional equipment identification step 30 and the vehicle inspection step 20. The report may be created in the form of a printed report or in a form that is electronically displayed by any device that can display such information.

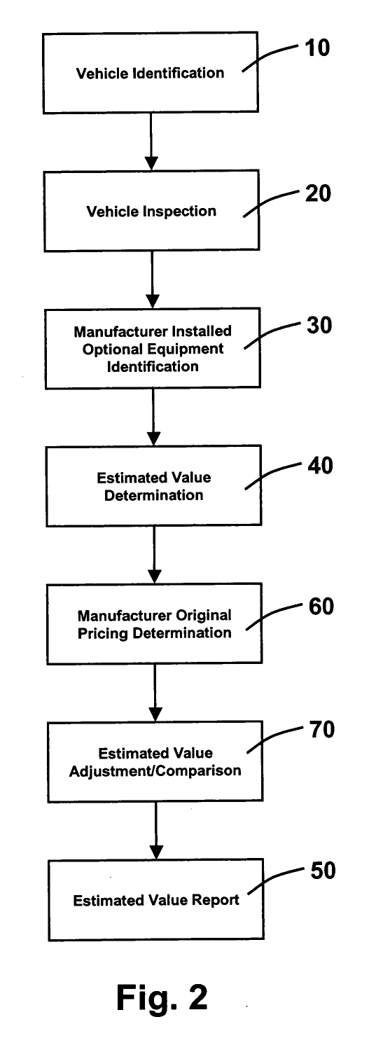

FIG. 2 is a flow chart of another embodiment of the method of the present invention in which additional information is considered in determining the estimated value of a used motor vehicle. The method disclosed by FIG. 2 includes a vehicle identification step 10, a vehicle inspection step 20, a manufacturer installed optional equipment identification step 30 and an estimated value determination step 40 as described above by reference to the embodiment illustrated by FIG. 1. After an estimated value is determined, the method as depicted by FIG. 2 includes a step in which manufacturer original pricing information is retrieved.

After as estimated value is determined by step 40, and the manufacturer original pricing information is retrieved, the estimated value is evaluated in view of the original pricing information to assure that the estimated value is appropriate in view of the vehicles condition and other information that is obtained in the vehicle inspection step 20. The original pricing information may be used to adjust the estimated value, or may be reported with the estimated value in the estimated report step 50. The original manufacturer pricing information provides a basis to assure the reliability of the estimated value determined by step 40. In situations in which determination of an estimated value is not possible because insufficient information that is conventionally used to estimate the value of a used motor vehicle is not available, as in the circumstance in which a very new automobile it being sold, the original manufacturer pricing information can alone provide a basis for estimating a value.

The method for valuing a used motor vehicle of the present invention has been described by reference to particular embodiments and specific contemplated variations. The description of this embodiment and these alternatives is not intended to limit the scope of the invention to specifically described aspects of the described embodiment and variations as it will be appreciated by those skilled in the art that the invention may be practiced other than as described. Therefore, the invention is not to be limited to the particular embodiment and variations disclosed. The scope of the invention encompasses all embodiments that fall within the scope of the appended claims.

I claim:

1. A method for valuing a used motor vehicle comprising the steps of:
acquiring information that identifies a used motor vehicle for which an estimated value is desired;
acquiring an identification of optional equipment with which the vehicle was originally provided from its manufacturer;
estimating the value of the used motor vehicle based at least in part on the optional equipment with which the used motor vehicle was originally provided; and
reporting the estimated value of the used motor vehicle
whereby an estimated value of the used motor vehicle is based at least in part on the optional equipment with which the vehicle was originally equipped.

2. The method for valuing a used motor vehicle of claim 1 further comprising the step of acquiring information about the condition of the motor vehicle and wherein the step of estimating the value of the used motor vehicle further comprises estimating the value of the used motor vehicle based on at least some of the information about the condition of the vehicle.

3. The method for valuing a used motor vehicle of claim 1 wherein identification of optional equipment with which a vehicle was originally equipped is acquired from a collection of information that is acquired from manufacturer's original invoices for new vehicles.

4. The method for valuing a used motor vehicle of claim 2 wherein identification of optional equipment with which a vehicle was originally equipped is acquired from a collection of information that is acquired from manufacturer's original invoices for new vehicles.

5. The method for valuing a used motor vehicle of claim 1 wherein the step of acquiring information about the used motor vehicle from an inspection includes acquiring an identification of optional equipment that is identified by an inspection and the step of estimating the value of the used motor vehicle further comprises comparing the optional equipment that is identified by the inspection to the optional equipment that is identified as originally provided by the manufacturer.

6. The method for valuing a used motor vehicle of claim 2 wherein the step of acquiring information about the used motor vehicle from an inspection includes acquiring an identification of optional equipment that is identified by an inspection and the step of estimating the value of the used motor vehicle further comprises comparing the optional equipment that is identified by the inspection to the optional equipment that is identified as originally provided by the manufacturer.

7. The method for valuing a used motor vehicle of claim 4 wherein identification of optional equipment with which a vehicle was originally equipped is acquired from a collection of information that is acquired from manufacturer's original invoices for new vehicles.

8. The method for valuing a used motor vehicle of claim 4 wherein the step of reporting the estimated value of the used motor vehicle includes reporting whether the optional equipment identified by the vehicle inspection is the same as the optional equipment that was originally identified by the manufacturer.

9. The method for valuing a used motor vehicle of claim 1 further comprising the steps of
acquiring manufacturer original pricing information for the used vehicle; and
comparing the estimated value of the used motor vehicle to the manufacturer original pricing;
and the step of reporting the estimated value of the used motor vehicle includes reporting original manufacturer pricing information.

10. The method for valuing a used motor vehicle of claim 2 further comprising the steps of
acquiring manufacturer original pricing information for the used vehicle; and
comparing the estimated value of the used motor vehicle to the manufacturer original pricing;
and the step of reporting the estimated value of the used motor vehicle includes reporting original manufacturer pricing information.

11. The method for valuing a used motor vehicle of claim 1 further comprising the steps of
acquiring manufacturer original pricing information for the used vehicle; and
comparing the estimated value of the used motor vehicle to the manufacturer original pricing;
and the step of estimating the value of the used motor vehicle includes determining an estimated value based in part on the original manufacturer pricing.

12. The method for valuing a used motor vehicle of claim 2 further comprising the steps of
acquiring manufacturer original pricing information for the used vehicle; and
comparing the estimated value of the used motor vehicle to the manufacturer original pricing;
and the step of estimating the value of the used motor vehicle includes determining an estimated value based in part on the original manufacturer pricing.

13. The method for valuing a used motor vehicle of claim 12 wherein the step of reporting the estimate value of the used motor vehicle includes reporting original manufacturer pricing information.

14. The method for valuing a used motor vehicle of claim 12 wherein identification of optional equipment with which a vehicle was originally equipped is acquired from a collection of information that is acquired from manufacturer's original invoices for new vehicles.

15. The method for valuing a used motor vehicle of claim 12 wherein the step of acquiring information about the condition of the used motor vehicle includes acquiring an identification of optional equipment and the step of estimating the value of the used motor vehicle further comprises comparing the optional equipment that is identified by the inspection to the optional equipment that is identified as originally provided by the manufacturer.

16. The method for valuing a used motor vehicle of claim 15 wherein identification of optional equipment with which a vehicle was originally equipped is acquired from a collection of information that is acquired from manufacturer's original invoices for new vehicles.
